(19) United States
(12) Patent Application Publication
(10) Pub. No.: US 2026/0330372 A1
(43) Pub. Date: Oct. 22, 2026

(54) PREDICT CHANGE REQUEST'S RISKS BASED ON COMPONENTS INTERRELATIONSHIP ISSUES

(71) Applicant: International Business Machines Corporation, Armonk, NY (US)

(72) Inventors: Aline Bossi, Piracicaba (BR); DIEGO BRITO VEIGA, Campinas (BR); Ana Paula Appel, São Paulo (BR); PAULO CAVALIN, RIO DE JANEIRO (BR)

(21) Appl. No.: 19/180,756

(22) Filed: Apr. 16, 2025

(51) Int. Cl. G06Q 10/0635

(52) U.S. Cl. CPC G06Q 10/0635

(57) ABSTRACT

A system includes a processor that executes computer executable components stored in a memory. The computer executable components can include an analysis component that evaluates historical change requests, identifies system dependencies, and detects interdependencies. The computer executable components can further include a recommendation component that uses a large language model and a knowledge graph to retrieve similar change requests and generate recommendations. The computer executable components can further include a mitigation component that calculates a risk score based on historical data, failures, and dependency analysis to provide preventive measures.

### TECHNICAL FIELD

The subject disclosure relates to risk-aware change management in production environments, e.g., improving change request outcomes through predictive analysis, dependency modeling, or through the application of large language models (LLMs) for enhanced decision making.

### BACKGROUND

A change request (CR) is a formal proposal to modify components within a live production environment. These changes can involve software, hardware, configurations, or other system elements, and can be essential for maintaining performance, addressing issues, and supporting ongoing improvements. The process of applying change requests (CRs) often requires detailed planning and coordination to minimize the risk of disruption to operational systems.

In practice, challenges can arise when change requests are not supported by complete or clear documentation, making it more difficult to evaluate their scope and potential impact. Additionally, in systems composed of many interconnected parts, changes to one component may affect others in unintended ways. Identifying and managing these dependencies can be complex and cannot always be fully addressed in existing workflows.

Variations in how change requests are implemented can contribute to inconsistencies in outcomes. Without standardized procedures, organizations can experience increased difficulty in maintaining traceability, reducing errors, or ensuring consistent results. While many tools and practices exist to manage these processes, there remains a need for approaches that enhance clarity, consistency, or impact awareness when applying changes in production environments.

### SUMMARY

The following presents a summary to provide a basic understanding of some embodiments of the invention. This summary is not intended to identify key or critical elements or delineate any scope of the particular embodiments or any scope of the claims. Its sole purpose is to present concepts in a simplified form as a prelude to the more detailed description that is presented later. In some embodiments described herein, systems, computer-implemented methods, and/or computer program products that facilitate intelligent and proactive change management in production environments are provided.

According to an embodiment, a system can comprise a processor that executes computer executable components stored in memory. The computer executable components can comprise an analysis component that evaluates historical change requests, identifies system dependencies, and detects interdependencies. The computer executable components can further comprise a recommendation component that uses a large language model and a knowledge graph to retrieve similar change requests and generate recommendations. The computer executable components can further comprise a mitigation component that calculates a risk score based on historical data, failures, and dependency analysis to provide preventive measures.

According to another embodiment, a computer-implemented method can comprise evaluating, by a system operatively coupled to a processor, historical change requests. The computer-implemented method comprises identifying, by a system, system dependencies. The computer-implemented method further comprises detecting, by a system, interdependencies. The computer implemented method can further comprise using, by the system, a large language model and a knowledge graph to retrieve similar change requests and generate recommendations. The computer implemented method can further comprise calculating, by the system, a risk score based on historical data, failures, and dependency analysis to provide preventive measures.

According to another embodiment, a computer program product comprising a computer readable storage medium having program instructions embodied therewith, the program instructions executable by a processor to cause the processor to evaluate, by the processor, historical change requests. The program instructions can also cause the processor to identify, by the processor, system dependencies. The program instructions can also cause the processor to detect, by the processor, interdependencies. The program instructions can further cause the processor to use, by the processor, a large language model and a knowledge graph to retrieve similar change requests and generate recommendations. The program instructions can cause the processor to calculate, by the processor, a risk score based on historical data, failures, and dependency analysis to provide preventive measures.

### BRIEF DESCRIPTION OF THE DRAWINGS

FIGS. 1 and 2 illustrate example systems that can facilitate intelligent and proactive change management in production environments in accordance with some embodiments described herein.

FIGS. 3 and 4 illustrate flow diagrams, of example computer implemented methods that can facilitate intelligent and proactive change management in production environments in accordance with some embodiments described herein.

FIG. 5 illustrates non-limiting example of a workflow for intelligent change request processing in accordance with embodiments of the present disclosure.

FIG. 6 illustrates an example system architecture for facilitating intelligent change request evaluation and approval, in accordance with one or more embodiments of the present disclosure.

FIG. 7 illustrates a block diagram of an example computing environment in which some embodiments described herein can be facilitated.

### DETAILED DESCRIPTION

The following detailed description is merely illustrative and is not intended to limit embodiments, applications, and/or uses of embodiments. Furthermore, there is no intention to be bound by any expressed or implied information presented in the preceding Background or Summary sections, or in the Detailed Description section.

A change request (CR) is a formal proposal to modify components within a live production environment. These changes can include software updates, hardware modifications, configuration adjustments, or policy shifts, and can be essential for maintaining system performance, introducing improvements, or addressing vulnerabilities or incidents. In modern operational environments change requests can be both frequent and necessary. However, ensuring their successful implementation remains a significant challenge due to the technical complexity, interdependencies between system components, and the human factors involved in executing these changes.

Change requests (CRs) often lack sufficient documentation making it difficult for teams to evaluate scope, assess risk, or plan properly for implementation. This can result in misunderstandings, misaligned assumptions, or ultimately flawed execution. Incomplete documentation can hamper post-change analysis, making it harder to identify root causes of issues or to implement improvements to future change processes.

Another challenge involves the interdependencies within systems composed of tightly coupled components. A change in one area can inadvertently impact other components in ways that are not immediately apparent. When these dependencies are not fully understood or documented, such changes can lead to unintended disruptions. Existing change management tools can lack the capability to identify and manage indirect or complex dependencies effectively.

Additionally, the lack of standardized procedures for implementing change requests can lead to inconsistent outcomes. Variability in how changes are reviewed, approved, tested, or deployed can introduce a higher likelihood of human error.

Due to the limitations described herein, there remains a more intelligent and proactive approach to managing change requests. The present disclosure addresses these shortcomings by introducing systems and methods that go beyond traditional procedural tools. The approach can incorporate predictive insights, analyze historical data, model system dependencies, or leverage large language models to enable informed approval or rejection of change requests. These capabilities can help reduce the likelihood of failure, minimize risk, and improve the overall success rate of change implementations.

According to an embodiment, a system can include a processor that executes computer executable components stored in a memory. The computer executable components can include an analysis component that evaluates historical change requests, identifies system dependencies, and detects interdependencies. The computer executable components can further include a recommendation component that uses a large language model and a knowledge graph to retrieve similar change requests and generate recommendations. The computer executable components can further include a mitigation component that calculates a risk score based on historical data, failures, and dependency analysis to provide preventive measures.

In various embodiments, the analysis component can extract entities from a change request using semantic role labeling to classify system components. In some embodiments, the analysis component can generate a system dependency graph using causal analysis. Entity extraction and graph generation can use various natural language processing, statistical, or rule-based techniques and can be adapted based on system domain, organizational needs, or user-defined rules.

In some embodiments, the recommendation component can retrieve similar change requests using multimodal fusion to combine text, system dependencies, or performance metrics. In various embodiments, the recommendation component can rank retrieved change requests using diversity-aware algorithms to ensure broad scenario representation. Multimodal fusion can incorporate other inputs such as user feedback, incident reports, or environmental variables. Ranking strategies can be dynamic and configurable depending on user preferences or operational priorities.

According to embodiments, the mitigation component can assign a risk score using uncertainty quantification and adjusts approval thresholds dynamically. Uncertainty quantification can involve statistical, probabilistic, or machine learning techniques. Approval thresholds can adapt based on system load, criticality of the change, or user role. The system is not limited to fixed scoring methods or rigid thresholds.

Embodiments can include a monitoring component that tracks system behavior post-change and updates historical data. In various embodiments, the monitoring component can apply anomaly detection to identify performance deviations and trigger rollback suggestions. Monitoring can occur in real time or at defined intervals, and a system can use multiple detection models operating in parallel. Rollback suggestions can be automatic or can be presented with justification for manual approval.

In one or more embodiments, the computer executable components can include a prescriptive analytics component that generates action recommendations using decision trees and optimization algorithms.

In at least one embodiment, the computer executable components can include an adaptive thresholding component that dynamically adjusts risk score thresholds based on system performance trends and user-defined risk tolerance. Thresholds can be adjusted continuously or in response to events, and can incorporate contextual variables such as time of day, system redundancy, or sensitivity of affected components.

Advantages of this system can include proactive risk mitigation, context aware recommendations, improved decision making, and increased efficiency.

According to some embodiments, the above-described computer system may be implemented as a computer-implemented method or as a computer program product.

Some embodiments of the present disclosure are now described with reference to the drawings. In the drawings, like referenced numerals are used to refer to like elements throughout. In the following description, for purposes of explanation, numerous specific details are set forth in order to provide a more thorough understanding of the embodiments. In various cases, some embodiments may be practiced without these specific details, yet a person having ordinary skill in the art will recognize that such embodiments are within metes and bounds of this disclosure.

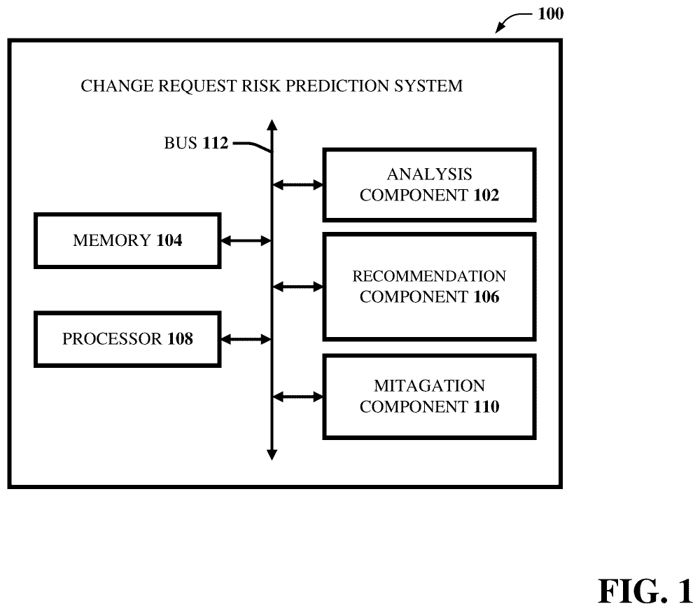

FIG. 1 illustrates an example system 100 for facilitating intelligent and proactive change management in production environments in accordance with some embodiments described herein. System 100 uses an analysis component 102, a recommendation component 106, and a mitigation component 110. The analysis component 102 evaluates historical change requests, identifies system dependencies, and detects interdependencies. The recommendation component 106 uses a large language model and a knowledge graph to retrieve similar change requests and generate recommendations. The mitigation component 110 calculates a risk score based on historical data, failures, and dependency analysis to provide preventive measures.

Aspects of systems (e.g., systems 100, 200, and the like), apparatuses, or processes in various embodiments of the present disclosure can constitute one or more machine-executable components embodied within one or more machines. For example, the components may be embodied in one or more computer readable mediums (or media) associated with one or more machines. Such components, when executed by one or more machines (e.g., computers, computing devices, virtual machines, etc.) can cause the machines to perform the operations described. System 100 can comprise an analysis component 102, a memory 104, a recommendation component 106, a processor 108, a mitigation component 110, and a system bus 112.

The system 100 and/or the components of the system 100 can use hardware and/or software to solve problems that are highly technical in nature. System 100 solves problems that are not abstract and that cannot be performed as a set of mental acts by a human. Further, some of the processes may be performed by specialized computers for carrying out defined tasks related to recovery plan development. The system 100 and/or components of the system 100 can be employed to solve new problems that arise through advancements in technologies. The system 100 can provide technical improvements to change requests by proactive risk mitigation, context aware recommendations, improved decision making, or increased efficiency.

System 100 may include a processor 108. In some embodiments, the processor 108 can execute a component or subcomponent associated with the system 100. Components or subcomponents associated with the system 100 can include one or more machine readable, writable, and/or executable instructions. In some embodiments, the system 100 can include a memory 104, and the memory 104 can store one or more components and/or subcomponents associated with the system 100. In some embodiments, the processor 108 can execute a component stored in the memory 104.

In some embodiments, the system 100 can include a computer-readable memory 104 that can be operably connected to the processor 108. The memory 104 can store computer-executable instructions that, upon execution by the processor 108, may cause the processor 108 and/or one or more other components of the system 100 (e.g., the analysis component 102, the recommendation component 106, and/or the mitigation component 110) to perform one or more actions. In some embodiments, the memory 104 can store computer-executable components (e.g., the analysis component 102, the recommendation component 106, and/or the mitigation component 110).

The system 100 and/or a component thereof as described herein can be communicatively, electrically, operatively, optically, and/or otherwise coupled to one another via a bus 112. The bus 112 can include one or more of a memory bus, memory controller, peripheral bus, external bus, local bus, and/or another type of bus that can employ one or more bus architectures. In some embodiments, the system 100 can be coupled (e.g., communicatively, electrically, operatively, optically, and/or the like) to one or more external systems (e.g., an electrical output production system, one or more output targets, an output target controller, and/or the like). In some embodiments, the system 100 can be coupled to one or more external sources, and/or devices (e.g., classical computing devices, communication devices, and/or like devices), such as via a network. In some embodiments, one or more of the components of the system 100 can reside in the cloud and/or locally in a local computing environment (e.g., at one or more specified locations).

In addition to the processor 108 and/or the memory 104 described above, the system 100 can include one or more computer and/or machine readable, writable, and/or executable components and/or instructions. When executed by the processor 108, these components and/or instructions can enable performance of one or more operations defined by the component(s) and/or instruction(s).

In various embodiments, the analysis component 102 can extract entities from a change request using semantic role labeling to classify system components. In some embodiments, the analysis component 102 can generate a system dependency graph using causal analysis.

In some embodiments, the recommendation component 106 can retrieve similar change requests using multimodal fusion to combine text, system dependencies, or performance metrics. In various embodiments, the recommendation component 106 can rank retrieved change requests using diversity-aware algorithms to ensure broad scenario representation.

According to embodiments, the mitigation component 110 can assign a risk score using uncertainty quantification and adjusts approval thresholds dynamically.

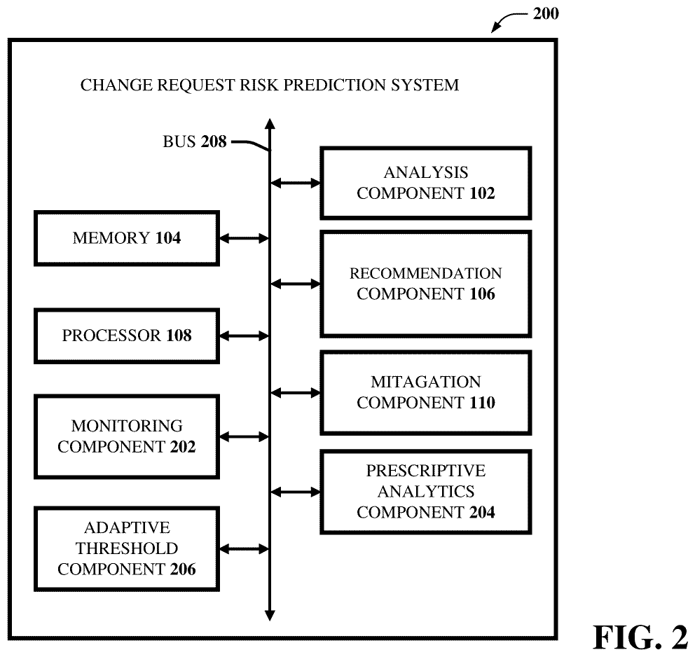

FIG. 2 illustrates an example system 200 that can facilitate intelligent and proactive change management in production environments. System 200 uses an analysis component 102, a recommendation component 106, a mitigation component 110, a monitoring component 202, a prescriptive analytics component 204, and an adaptive threshold component 206. The analysis component 102 evaluates historical change requests, identifies system dependencies, and detects interdependencies. The recommendation component 106 uses a large language model and a knowledge graph to retrieve similar change requests and generate recommendations. The mitigation component 110 calculates a risk score based on historical data, failures, and dependency analysis to provide preventive measures. Description of like components has been omitted for the sake of brevity.

Embodiments can include a monitoring component 202 that tracks system behavior post-change and updates historical data. In various embodiments, the monitoring component 202 can apply anomaly detection to identify performance deviations and trigger rollback suggestions.

In one or more embodiments, the computer executable components can include a prescriptive analytics component 204 that generates action recommendations using decision trees and optimization algorithms.

In at least one embodiment, the computer executable components can include an adaptive threshold component 206 that dynamically adjusts risk score thresholds based on system performance trends and user-defined risk tolerance.

The systems and/or devices are described herein with respect to interaction between one or more components. Such systems and/or components can include the components and/or sub-components specified therein, one or more of the specified components and/or sub-components, and/or additional components. Sub-components can be implemented as components communicatively coupled to other components rather than included within parent components. One or more components and/or sub-components can be combined into a single component providing aggregate functionality. The components can interact with one or more other components not specifically described herein for the sake of brevity but known by those of skill in the art.

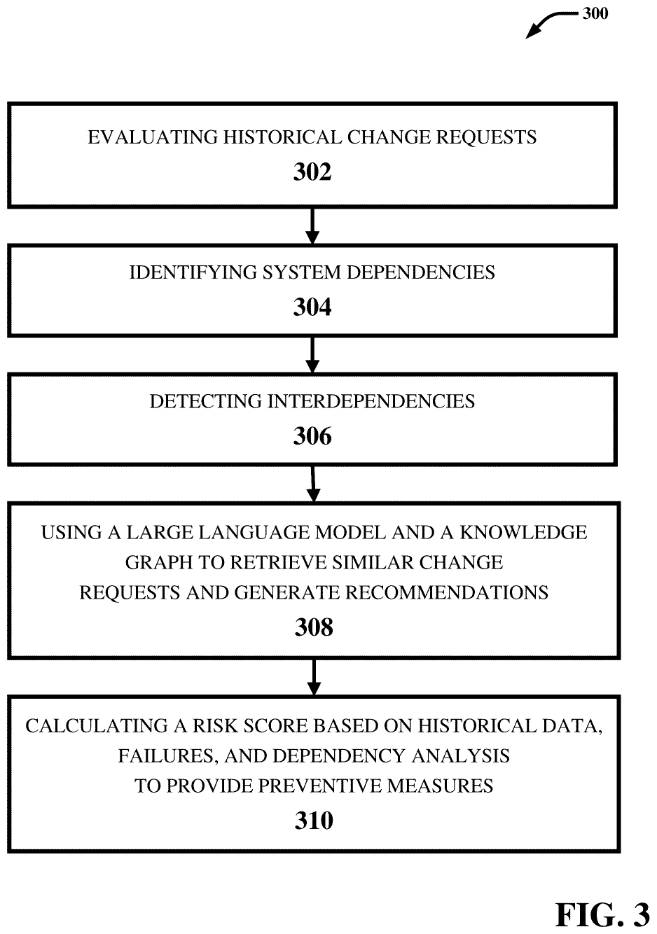

Next, FIG. 3 illustrates a flow diagram of a method 300 that can facilitate intelligent and proactive change management in production environments in accordance with some embodiments described herein, such as the system 200 of FIG. 2 and the system 100 of FIG. 1. While the method 300 is described relative to the system 200 of FIG. 2, the method 300 can be applicable also to other systems described herein. Repetitive description of like elements and/or processes employed in respective embodiments is omitted for sake of brevity.

For simplicity of explanation, the computer-implemented methods provided herein are depicted and/or described as a series of actions. It is to be understood that the subject matter is not limited by the actions illustrated and/or by the order thereof. For example, actions can occur in one or more orders, concurrently, and/or with other acts not presented and described herein. Furthermore, not all illustrated actions can be utilized to implement the computer-implemented methods in accordance with the described subject matter. In addition, the computer-implemented methods could alternatively be represented as a series of interrelated states via a state diagram or events. Additionally, the computer-implemented methods described in this specification are capable of being stored on an article of manufacture to facilitate transporting and transferring the computer-implemented methods to computers. The term article of manufacture, as used herein, encompasses a computer program accessible from any computer-readable device or storage media.

At 302, the method 300 includes evaluating historical change requests. The method 300 can use a system operatively coupled to the processor (e.g., analysis component 102) to evaluate historical change requests. This evaluation can involve analyzing patterns, identifying prior outcomes, or extracting key features from past requests to inform future decision-making. In some embodiments, the analysis is not limited to structured data and can include unstructured text, logs, or metadata associated with each request.

At 304, method 300 includes identifying system dependencies. The method 300 can use a system operatively coupled to the processor (e.g., analysis component 102) to identify system dependencies. These dependencies can include both direct and indirect relationships between components, services, or subsystems. The identification process is not limited to any specific system architecture.

At 306, method 300 includes detecting interdependencies. The method 300 can use a system operatively coupled to the processor (e.g., analysis component 102) to detect interdependencies. Interdependencies can span across applications, services, users, or environments, and can be inferred from system behavior, historical failures, or communication patterns. In some implementations, interdependencies can be modeled probabilistically or through graph-based structures to capture dynamic or non-obvious relationships.

At 308, method 300 includes using a large language model and a knowledge graph to retrieve similar change requests and generate recommendations. The method 300 can use a system operatively coupled to the processor (e.g., recommendation component 106) to use a large language model and a knowledge graph to retrieve similar change requests and generate recommendations. The language model can be trained on domain-specific documentation, historical change requests, or other data sources, and the recommendations can consider technical or organizational context. Retrieval and generation processes are not limited to any specific algorithm and can involve neural embeddings, semantic similarity, or rule-based filters depending on implementation.

At 310, method 300 includes calculating a risk score based on historical data, failures, and dependency analysis to provide preventive measures. The method 300 can use a system operatively coupled to the processor (e.g., mitigation component 110) to calculate a risk score based on historical data, failures, and dependency analysis to provide preventive measures. The risk score can be generated using statistical models, machine learning algorithms, or probabilistic inference methods. In certain embodiments, the score can be accompanied by a confidence interval or qualitative categorization (e.g., low, medium, high), and can adapt dynamically based on evolving system conditions or user-defined risk tolerance.

In some embodiments, method 300 is performed by a system, such as system 100 of FIG. 1 or system 200 of FIG. 2. The evaluating historical change requests 302 can be performed by an analysis component (e.g., analysis component 102 of FIG. 1). The identifying system dependencies 304 can be performed by an analysis component (e.g., analysis component 102). Detecting interdependencies 306 can be performed by an analysis component (e.g., analysis component 102). The using a large language model and a knowledge graph to retrieve similar change requests and generate recommendations 308 can be performed by a recommendation component (e.g., recommendation component 106). Calculating a risk score based on historical data, failures, and dependency analysis to provide preventive measures 310 can be performed by a mitigation component (e.g., mitigation component 110).

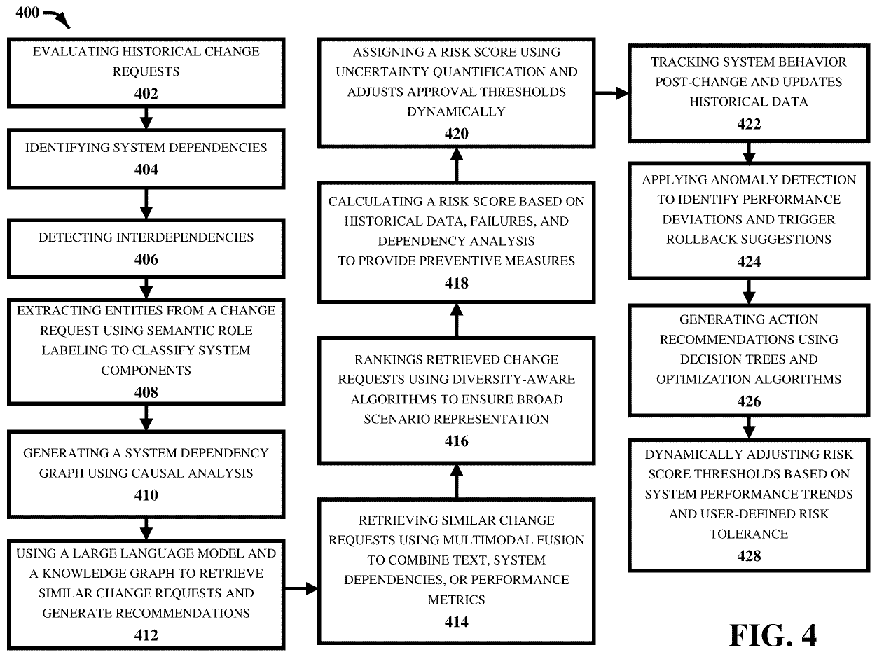

Next, FIG. 4 illustrates a flow diagram of a method 400 that can facilitate intelligent and proactive change management in production environments in accordance with some embodiments described herein. While the method 400 is described relative to the system 100 of FIG. 1, the method 400 can be applicable also to other systems described herein. a

At 402, the method 400 includes evaluating historical change requests. The method 400 can use a system operatively coupled to the processor (e.g., analysis component 102) to evaluate historical change requests. This evaluation can include identifying patterns, recurring issues, resolution outcomes, or system states that contributed to success or failure. In some embodiments, structured logs or unstructured textual data can be analyzed.

At 404, method 400 includes identifying system dependencies. The method 400 can use a system operatively coupled to the processor (e.g., analysis component 102) to identify system dependencies. Dependencies can include hardware, software, configuration elements, or external services. The identification process can utilize static configuration files, real-time telemetry, or knowledge graphs and is not limited to any specific data source.

At 406, method 400 includes detecting interdependencies. The method 400 can use a system operatively coupled to the processor (e.g., analysis component 102) to detect interdependencies. These interdependencies can represent cascading effects, shared resource usage, or control flow relationships, and can span across applications, subsystems, or user roles. Detection techniques can include graph analysis, correlation modeling, or behavioral inference.

At 408, method 400 includes extracting entities from a change request using semantic role labeling to classify system components. The method 400 can use a system operatively coupled to the processor (e.g., analysis component 102) to extract entities from a change request using semantic role labeling to classify system components. Entities can include systems, modules, users, actions, or outcomes. Classification can be informed by contextual data, such as a change type or target environment. In some embodiments, domain-specific entity libraries can be applied.

At 410, method 400 includes generating a system dependency graph using causal analysis. The method 400 can use a system operatively coupled to the processor (e.g., analysis component 102) to generate a system dependency graph using causal analysis. Causal analysis can be performed using observational data, historical incidents, or configuration hierarchies to determine cause-and-effect relationships between system elements. A graph can evolve over time and can incorporate probabilistic or time-series elements.

At 412, method 400 includes using a large language model and a knowledge graph to retrieve similar change requests and generate recommendations. The method 400 can use a system operatively coupled to the processor (e.g., recommendation component 106) to use a large language model and a knowledge graph to retrieve similar change requests and generate recommendations. A large language model can be trained on organization-specific documentation, tickets, or manuals. A knowledge graph can include formal relationships between systems, components, or operational outcomes. Recommendations can include procedural suggestions, configuration hints, or impact forecasts.

At 414, method 400 includes retrieving similar change requests using multimodal fusion to combine text, system dependencies, or performance metrics. The method 400 can use a system operatively coupled to the processor (e.g., recommendation component 106) to retrieve similar change requests using multimodal fusion to combine text, system dependencies, or performance metrics. Multimodal fusion can integrate various data types, including logs, metrics, or semantic vectors, to produce a unified representation that improves retrieval relevance. A fusion approach can be rule-based, learned, or hybrid.

At 416, method 400 includes ranking retrieved change requests using diversity-aware algorithms to ensure broad scenario representation. The method 400 can use a system operatively coupled to the processor (e.g., recommendation component 106) to rank retrieved change requests using diversity-aware algorithms to ensure broad scenario representation. These algorithms can prioritize not just similarity, but variance in system type, user, environment, or resolution strategy to provide more comprehensive context. In some embodiments, metrics can be defined dynamically based on user role or query intent.

At 418, method 400 includes calculating a risk score based on historical data, failures, and dependency analysis to provide preventive measures. The method 400 can use a system operatively coupled to the processor (e.g., mitigation component 110) to calculate a risk score based on historical data, failures, and dependency analysis to provide preventive measures. Risk scores can reflect quantitative metrics (e.g., failure rate, change complexity) or qualitative assessments (e.g., confidence level), and can be recalculated as more data becomes available.

At 420, method 400 includes assigning a risk score using uncertainty quantification and adjusts approval thresholds dynamically. The method 400 can use a system operatively coupled to the processor (e.g., mitigation component 110) to assign a risk score using uncertainty quantification and adjusts approval thresholds dynamically. Approval thresholds can be adjusted in real time based on system stability, load, or organizational risk appetite.

At 422, method 400 includes tracking system behavior post-change and updates historical data. The method 400 can use a system operatively coupled to the processor (e.g., monitoring component 202) to track system behavior post-change and updates historical data. Behavior tracking can include monitoring performance metrics, error rates, or system logs. In some embodiments, anomaly scoring or root cause correlation can also be recorded as part of a historical profile.

At 424, method 400 includes applying anomaly detection to identify performance deviations and trigger rollback suggestions. The method 400 can use a system operatively coupled to the processor (e.g., monitoring component 202) to apply anomaly detection to identify performance deviations and trigger rollback suggestions. Anomaly detection techniques can include threshold-based alerts, machine learning models, or hybrid systems. Rollback suggestions can be automated or provided with justification for manual review.

At 426, method 400 includes generating action recommendations using decision trees and optimization algorithms. The method 400 can use a system operatively coupled to the processor (e.g., prescriptive analytics component 204) to generate action recommendations using decision trees and optimization algorithms. Recommendations can include step-by-step remediation guidance, rollback procedures, or alternative configurations. Optimization goals can vary by system priority, user-defined constraints, or risk reduction objectives.

At 428, method 400 includes dynamically adjusting risk score thresholds based on system performance trends and user-defined risk tolerance. The method 400 can use a system operatively coupled to the processor (e.g., adaptive threshold component 206) to dynamically adjust risk score thresholds based on system performance trends and user-defined risk tolerance. This adjustment can be performed continuously or in response to events, and can consider recent system anomalies, service level objectives, or changing user roles and permissions.

One or more systems, devices, computer program products, and/or computer-implemented methods provided herein relate to refinement of generated code models. A system can include a processor that executes computer executable components stored in memory. The computer executable components can include an analysis component that evaluates historical change requests, identifies system dependencies, and detects interdependencies. The computer executable components can further include a recommendation component that uses a large language model and a knowledge graph to retrieve similar change requests and generate recommendations. The computer executable components can further include a mitigation component that calculates a risk score based on historical data, failures, and dependency analysis to provide preventive measures. The computer executable components can include a monitoring component that tracks system behavior post-change and updates historical data. The computer executable include can further comprise a prescriptive analytics component that generates action recommendations using decision trees and optimization algorithms. The computer executable components can include an adaptive thresholding component that dynamically adjusts risk score thresholds based on system performance trends and user-defined risk tolerance.

Advantages of this system can include proactive risk mitigation, context aware recommendations, improved decision making, and increased efficiency.

In various embodiments, the analysis component can extract entities from a change request using semantic role labeling to classify system components. In some embodiments, the analysis component can generate a system dependency graph using causal analysis. Entity extraction and graph generation can use various natural language processing, statistical, or rule-based techniques and can be adapted based on system domain, organizational needs, or user-defined rules.

In some embodiments, the recommendation component can retrieve similar change requests using multimodal fusion to combine text, system dependencies, or performance metrics. In various embodiments, the recommendation component can rank retrieved change requests using diversity-aware algorithms to ensure broad scenario representation. Multimodal fusion can incorporate other inputs such as user feedback, incident reports, or environmental variables. Ranking strategies can be dynamic and configurable depending on user preferences or operational priorities.

According to embodiments, the mitigation component can assign a risk score using uncertainty quantification and adjusts approval thresholds dynamically. Uncertainty quantification can involve statistical, probabilistic, or machine learning techniques. Approval thresholds can adapt based on system load, criticality of the change, or user role. The system is not limited to fixed scoring methods or rigid thresholds.

In various embodiments, the monitoring component can apply anomaly detection to identify performance deviations and trigger rollback suggestions. Monitoring can occur in real time or at defined intervals, and a system can use multiple detection models operating in parallel. Rollback suggestions can be automatic or can be presented with justification for manual approval.

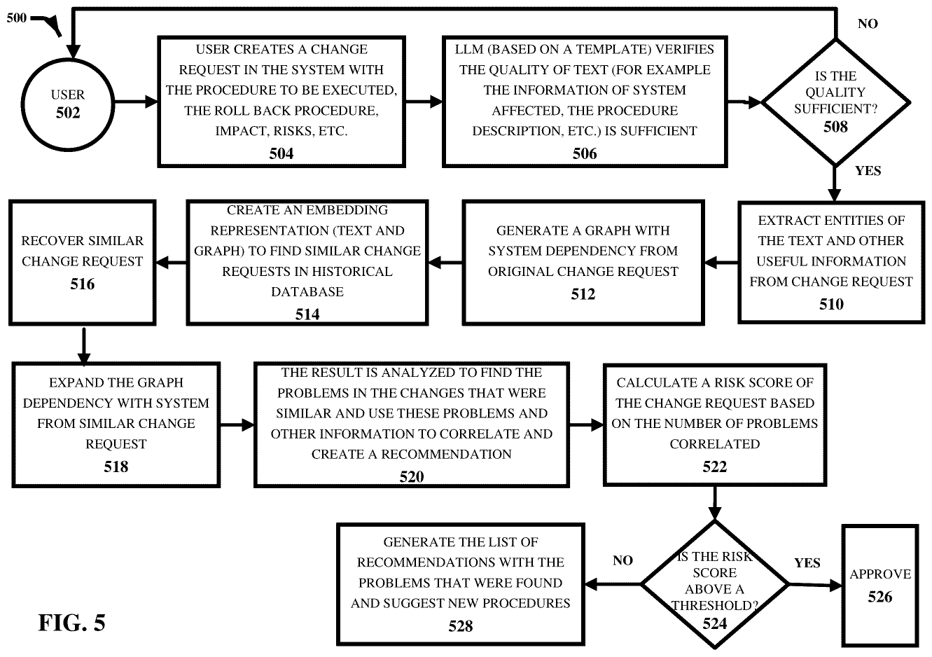

FIG. 5 illustrates non-limiting example of a workflow for intelligent change request processing in accordance with embodiments of the present disclosure.

At step 502, a user can access the system to initiate a change request. As shown in step 504, the user can provide a detailed description of a proposed change, such as its purpose, implementation procedure, or relevant contextual information. This contextual information can include, but is not limited to, system configuration data, user roles, or environmental conditions.

In step 506, the system can utilize a large language model integrated with a knowledge graph to analyze a submitted text. This analysis can involve evaluating the quality or completeness of a request using natural language processing techniques. A knowledge graph can be used to detect relevant dependencies, conflicts, or relationships with existing system components, enabling a more holistic understanding of a change context.

If the change request meets a defined quality threshold, the system can proceed to step 508, where it performs historical analysis by comparing a request to previously submitted change requests. Clustering algorithms can be used to group similar requests, while anomaly detection techniques can identify requests that deviate from common patterns. This allows a system to uncover trends, estimate resource requirements, or inform the appropriate approval workflow. If a request does not meet quality standards, the process can return to step 502 for user revision.

In step 510, semantic role labeling techniques can be applied to extract entities from the change request and related inputs. These entities can represent components, systems, users, or other relevant factors involved in a proposed change. The roles these entities play (e.g., affected systems or responsible parties) can also be identified.

At step 512, a dependency graph can be generated to model relationships among system components potentially impacted by a change. This graph can be created using causal inference techniques and can be supplemented with historical system behaviour, operational metrics, or domain-specific documentation. In some embodiments, large language models may be trained on technical documentation to further enrich the dependency mapping and compatibility analysis.

At step 514, a system can involve the generation of a unified embedding representation that incorporates information from change request text, extracted entities, dependency graphs, or other relevant data such as logs and performance metrics. Multimodal fusion techniques can be applied to combine these diverse data sources effectively.

In step 516, a system can retrieve similar historical change requests using an embedding representation. Diversity-aware ranking algorithms can be employed to ensure that retrieved examples cover a broad range of relevant scenarios, aiding in robust comparison.

The graph of system dependencies can be further expanded in step 518, incorporating insights from similar change requests. Probabilistic graphical models can be used to account for uncertainty and model complexity of real-world systems.

Step 520 can involve automatic summarization of the results using a large language model. Explainability techniques such as model interpretability or feature attribution can be applied to provide transparency into a system's reasoning. An output can include correlated issues found in similar change requests and targeted recommendations to enhance the success of a proposed change.

At step 522, the system can compute a risk score associated with the change request. This score may be based on the severity and number of recommendations, the type of change request, and related factors. Uncertainty quantification techniques can be used to provide a confidence interval for the risk estimate.

Step 524 illustrates the approval decision process. A dynamic threshold can be adjusted based on system performance history and the user's risk tolerance. If a risk score exceeds a dynamic threshold the change request can be rejected or flagged for revision. Otherwise, the change request can be approved.

Following approval, step 526 can include presenting conditional recommendations to a user based on an assessed risk and system performance data. In step 528, a system can generate a list of actionable insights and prescriptive guidance, using techniques such as decision trees or optimization algorithms. Additionally, a system can continue to learn from new data to enhance the performance of the underlying language model and the quality of future evaluations.

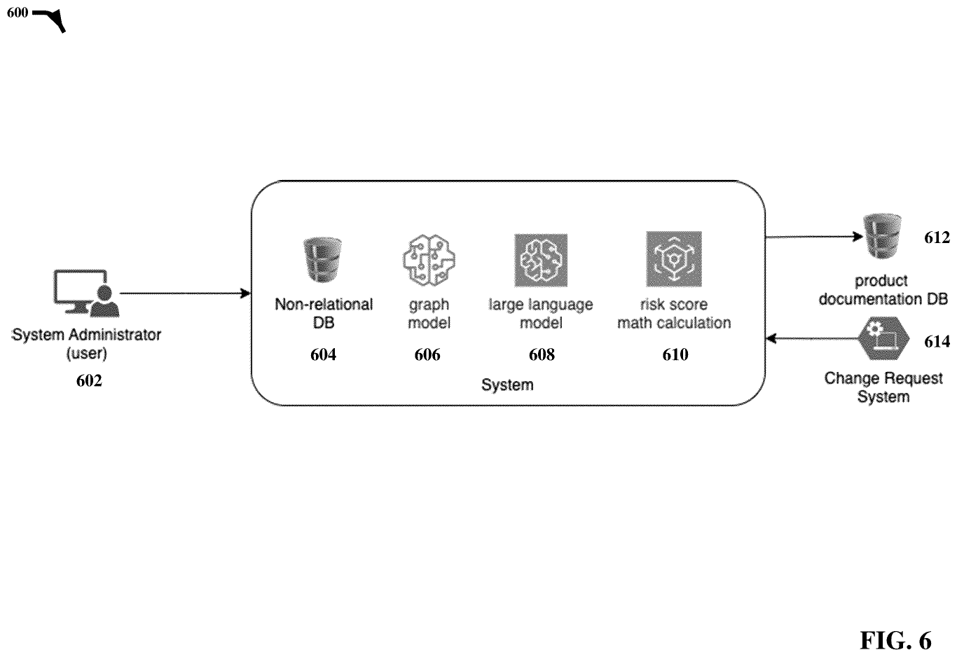

FIG. 6 illustrates an example system architecture for facilitating intelligent change request evaluation and approval, in accordance with one or more embodiments of the present disclosure.

A system administrator or other authorized user 602 can interact with a system to submit, review, or manage change requests. The user interface can enable entry of relevant data and can serve as an entry point for initiating an analysis process described herein.

The system can include several integrated components configured to perform different aspects of a change request evaluation. In some embodiments, a non-relational database 604 can be used to store unstructured or semi-structured data associated with submitted change requests, including descriptions, contextual metadata, logs, or associated documents.

A graph model 606 can be used to represent system components and their interdependencies. This model can support analysis of relationships, conflict detection, or propagation of potential impact throughout a system. A graph model can be generated or updated using data from prior change requests, system telemetry, or technical documentation.

A large language model 608 can be incorporated to interpret or evaluate a textual content of a change request. In some embodiments, a model can be trained on both internal system documentation and external sources to provide domain-specific language understanding. This model can support tasks such as quality assessment, entity recognition, summarization, or recommendation generation.

A risk scoring component 610 can be responsible for calculating a numerical or categorical risk score based on multiple input variables. These can include, but are not limited to, completeness of a change request, dependency complexity, potential conflicts, historical precedents, or severity of past similar issues. Uncertainty quantification techniques can be used to provide a confidence interval associated with a calculated score.

The system can also access a product documentation database 612, which can contain technical manuals, configuration guides, compatibility matrices, or system-specific references. This information can be used to enrich a language model's contextual understanding and inform a dependency graph and risk model.

A change request system 614 can serve as an orchestrator, receiving user input and coordinating operations across a system's components. In some embodiments, a change request system can provide the user interface, enforce approval workflows, and present recommendations, risk scores, or supporting evidence to a user.

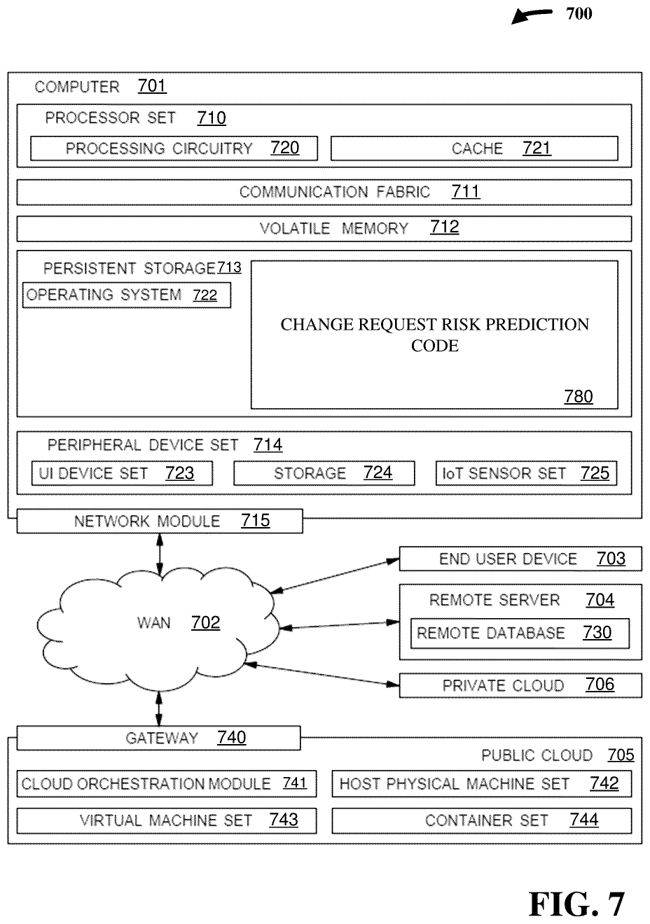

FIG. 7 and the following discussion are intended to provide a brief, general description of a suitable computing environment 700 in which some embodiments described herein can be implemented. For example, various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks can be performed in reverse order, as a single integrated step, concurrently or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium can be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include diskette, hard disk, random access memory (RAM), read-only memory (ROM), erasable programmable read-only memory (EPROM or Flash memory), static random-access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 700 contains an example of an environment for the execution of at least some of the computer code involved in performing the inventive methods, such as change request risk prediction code 780. In addition to block 780, computing environment 700 includes, for example, computer 701, wide area network (WAN) 702, end user device (EUD) 703, remote server 704, public cloud 705, and private cloud 706. In this embodiment, computer 701 includes processor set 710 (including processing circuitry 720 and cache 721), communication fabric 711, volatile memory 712, persistent storage 713 (including operating system 722 and block 780, as identified above), peripheral device set 714 (including user interface (UI), device set 723, storage 724, and Internet of Things (IoT) sensor set 725), and network module 715. Remote server 704 includes remote database 730. Public cloud 705 includes gateway 740, cloud orchestration module 741, host physical machine set 742, virtual machine set 743, and container set 744.

COMPUTER 701 can take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 730. As is well understood in the art of computer technology, and depending upon the technology, performance of a computer-implemented method can be distributed among multiple computers and/or between multiple locations. On the other hand, in this presentation of computing environment 700, detailed discussion is focused on a single computer, specifically computer 701, to keep the presentation as simple as possible. Computer 701 can be located in a cloud, even though it is not shown in a cloud in FIG. 7. On the other hand, computer 701 is not required to be in a cloud except to any extent as can be affirmatively indicated.

PROCESSOR SET 710 includes one, or more, computer processors of any type now known or to be developed in the future. Processing circuitry 720 can be distributed over multiple packages, for example, multiple, coordinated integrated circuit chips. Processing circuitry 720 can implement multiple processor threads and/or multiple processor cores. Cache 721 is memory that is located in the processor chip package(s) and is typically used for data or code that should be available for rapid access by the threads or cores running on processor set 710. Cache memories are typically organized into multiple levels depending upon relative proximity to the processing circuitry. Alternatively, some, or all, of the cache for the processor set can be located “off chip.” In some computing environments, processor set 710 can be designed for working with qubits and performing quantum computing.

Computer readable program instructions are typically loaded onto computer 701 to cause a series of operational steps to be performed by processor set 710 of computer 701 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 721 and the other storage media discussed below. The program instructions, and associated data, are accessed by processor set 710 to control and direct performance of the inventive methods. In computing environment 700, at least some of the instructions for performing the inventive methods can be stored in block 780 in persistent storage 713.

COMMUNICATION FABRIC 711 is the signal conduction path that allows the various components of computer 701 to communicate with each other. Typically, this fabric is made of switches and electrically conductive paths, such as the switches and electrically conductive paths that make up busses, bridges, physical input/output ports and the like. Other types of signal communication paths can be used, such as fiber optic communication paths and/or wireless communication paths.

VOLATILE MEMORY 712 is any type of volatile memory now known or to be developed in the future. Examples include dynamic type random access memory (RAM) or static type RAM. Typically, the volatile memory is characterized by random access, but this is not required unless affirmatively indicated. In computer 701, the volatile memory 712 is located in a single package and is internal to computer 701, but, alternatively or additionally, the volatile memory can be distributed over multiple packages and/or located externally with respect to computer 701.

PERSISTENT STORAGE 713 is any form of non-volatile storage for computers that is now known or to be developed in the future. The non-volatility of this storage means that the stored data is maintained regardless of whether power is being supplied to computer 701 and/or directly to persistent storage 713. Persistent storage 713 can be a read only memory (ROM), but typically at least a portion of the persistent storage allows writing of data, deletion of data and re-writing of data. Some familiar forms of persistent storage include magnetic disks and solid-state storage devices. Operating system 722 can take several forms, such as various known proprietary operating systems or open-source Portable Operating System Interface type operating systems that employ a kernel. The code included in block 780 typically includes at least some of the computer code involved in performing the inventive methods.

PERIPHERAL DEVICE SET 714 includes the set of peripheral devices of computer 701. Data communication connections between the peripheral devices and the other components of computer 701 can be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet. In various embodiments, UI device set 723 can include components such as a display screen, speaker, microphone, wearable devices (such as goggles and smart watches), keyboard, mouse, printer, touchpad, game controllers, and haptic devices. Storage 724 is external storage, such as an external hard drive, or insertable storage, such as an SD card. Storage 724 can be persistent and/or volatile. In some embodiments, storage 724 can take the form of a quantum computing storage device for storing data in the form of qubits. In embodiments where computer 701 is required to have a large amount of storage (for example, where computer 701 locally stores and manages a large database) then this storage can be provided by peripheral storage devices designed for storing large amounts of data, such as a storage area network (SAN) that is shared by multiple, geographically distributed computers. IoT sensor set 725 is made up of sensors that can be used in Internet of Things applications. For example, one sensor can be a thermometer, and another sensor can be a motion detector.

NETWORK MODULE 715 is the collection of computer software, hardware, and firmware that allows computer 701 to communicate with other computers through WAN 702. Network module 715 can include hardware, such as modems or Wi-Fi signal transceivers, software for packetizing and/or de-packetizing data for communication network transmission, and/or web browser software for communicating data over the internet. In some embodiments, network control functions and network forwarding functions of network module 715 are performed on the same physical hardware device. In other embodiments (for example, embodiments that utilize software-defined networking (SDN)), the control functions and the forwarding functions of network module 715 are performed on physically separate devices, such that the control functions manage several different network hardware devices. Computer readable program instructions for performing the inventive methods can typically be downloaded to computer 701 from an external computer or external storage device through a network adapter card or network interface included in network module 715.

WAN 702 is any wide area network (for example, the internet) capable of communicating computer data over non-local distances by any technology for communicating computer data, now known or to be developed in the future. In some embodiments, the WAN can be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 703 is any computer system that is used and controlled by an end user (for example, a customer of an enterprise that operates computer 701) and can take any of the forms discussed above in connection with computer 701. EUD 703 typically receives helpful and useful data from the operations of computer 701. For example, in a hypothetical case where computer 701 is designed to provide a recommendation to an end user, this recommendation would typically be communicated from network module 715 of computer 701 through WAN 702 to EUD 703. In this way, EUD 703 can display, or otherwise present, the recommendation to an end user. In some embodiments, EUD 703 can be a client device, such as thin client, heavy client, mainframe computer and/or desktop computer.

REMOTE SERVER 704 is any computer system that serves at least some data and/or functionality to computer 701. Remote server 704 can be controlled and used by the same entity that operates computer 701. Remote server 704 represents the machine(s) that collect and store helpful and useful data for use by other computers, such as computer 701. For example, in a hypothetical case where computer 701 is designed and programmed to provide a recommendation based on historical data, then this historical data can be provided to computer 701 from remote database 730 of remote server 704.

PUBLIC CLOUD 705 is any computer system available for use by multiple entities that provides on-demand availability of computer system resources and/or other computer capabilities, especially data storage (cloud storage) and computing power, without direct active management by the scale. The direct and active management of the computing resources of public cloud 705 is performed by the computer hardware and/or software of cloud orchestration module 741. The computing resources provided by public cloud 705 are typically implemented by virtual computing environments that run on various computers making up the computers of host physical machine set 742, which is the universe of physical computers in and/or available to public cloud 705. The virtual computing environments (VCEs) typically take the form of virtual machines from virtual machine set 743 and/or containers from container set 744. It is understood that these VCEs can be stored as images and can be transferred among and between the various physical machine hosts, either as images or after instantiation of the VCE. Cloud orchestration module 741 manages the transfer and storage of images, deploys new instantiations of VCEs and manages active instantiations of VCE deployments. Gateway 740 is the collection of computer software, hardware and firmware allowing public cloud 705 to communicate through WAN 702.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 706 is similar to public cloud 705, except that the computing resources are only available for use by a single enterprise. While private cloud 706 is depicted as being in communication with WAN 702, in other embodiments a private cloud can be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 705 and private cloud 706 are both part of a larger hybrid cloud. The embodiments described herein can be directed to one or more of a system, a method, an apparatus, and/or a computer program product at any possible technical detail level of integration. The computer program product can include a computer readable storage medium (or media) having computer readable program instructions thereon for causing a processor to carry out aspects of some of the embodiments described herein. The computer readable storage medium can be a tangible device that can retain and store instructions for use by an instruction execution device. The computer readable storage medium can be, for example, but is not limited to, an electronic storage device, a magnetic storage device, an optical storage device, an electromagnetic storage device, a superconducting storage device and/or any suitable combination of the foregoing. A non-exhaustive list of more specific examples of the computer readable storage medium can also include the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon and/or any suitable combination of the foregoing. A computer readable storage medium, as used herein, is not to be construed as being transitory signals per se, such as radio waves and/or other freely propagating electromagnetic waves, electromagnetic waves propagating through a waveguide and/or other transmission media (e.g., light pulses passing through a fiber-optic cable), and/or electrical signals transmitted through a wire.

Computer readable program instructions described herein can be downloaded to respective computing/processing devices from a computer readable storage medium and/or to an external computer or external storage device via a network, for example, the Internet, a local area network, a wide area network and/or a wireless network. The network can comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device. Computer readable program instructions for carrying out operations of some of the embodiments described herein can be assembler instructions, instruction-set-architecture (ISA) instructions, machine instructions, machine dependent instructions, microcode, firmware instructions, state-setting data, configuration data for integrated circuitry, and/or source code and/or object code written in any combination of one or more programming languages, including an object oriented programming language such as Smalltalk, C++ or the like, and/or procedural programming languages, such as the “C” programming language and/or similar programming languages. The computer readable program instructions can execute entirely on a computer, partly on a computer, as a stand-alone software package, partly on a computer and/or partly on a remote computer or entirely on the remote computer and/or server. In the latter scenario, the remote computer can be connected to a computer through any type of network, including a local area network (LAN) and/or a wide area network (WAN), and/or the connection can be made to an external computer (for example, through the Internet using an Internet Service Provider). In some embodiments, electronic circuitry including, for example, programmable logic circuitry, field-programmable gate arrays (FPGA) and/or programmable logic arrays (PLA) can execute the computer readable program instructions by utilizing state information of the computer readable program instructions to personalize the electronic circuitry, in order to perform aspects of some of the embodiments described herein.

Aspects of some of the embodiments described herein are described with reference to flowchart illustrations and/or block diagrams of methods, apparatus (systems), and computer program products according to some embodiments described herein. It will be understood that each block of the flowchart illustrations and/or block diagrams, and combinations of blocks in the flowchart illustrations and/or block diagrams, can be implemented by computer readable program instructions. These computer readable program instructions can be provided to a processor of a general-purpose computer, special purpose computer and/or other programmable data processing apparatus to produce a machine, such that the instructions, which execute via the processor of the computer or other programmable data processing apparatus, can create means for implementing the functions/acts specified in the flowchart and/or block diagram block or blocks. These computer readable program instructions can also be stored in a computer readable storage medium that can direct a computer, a programmable data processing apparatus and/or other devices to function in a particular manner, such that the computer readable storage medium having instructions stored therein can comprise an article of manufacture including instructions which can implement aspects of the function/act specified in the flowchart and/or block diagram block or blocks. The computer readable program instructions can also be loaded onto a computer, other programmable data processing apparatus and/or other device to cause a series of operational acts to be performed on the computer, other programmable apparatus and/or other device to produce a computer implemented process, such that the instructions which execute on the computer, other programmable apparatus and/or other device implement the functions/acts specified in the flowchart and/or block diagram block or blocks.

The flowcharts and block diagrams in the figures illustrate the architecture, functionality, and/or operation of possible implementations of systems, computer-implementable methods, and/or computer program products according to some embodiments described herein. In this regard, each block in the flowchart or block diagrams can represent a module, segment, and/or portion of instructions, which comprises one or more executable instructions for implementing the specified logical function. In one or more alternative implementations, the functions noted in the blocks can occur out of the order noted in the Figures. For example, two blocks shown in succession can be executed substantially concurrently, and/or the blocks can sometimes be executed in the reverse order, depending upon the functionality involved. It will also be noted that each block of the block diagrams and/or flowchart illustration, and/or combinations of blocks in the block diagrams and/or flowchart illustration, can be implemented by special purpose hardware-based systems that can perform the specified functions and/or acts and/or carry out one or more combinations of special purpose hardware and/or computer instructions.

While the subject matter has been described above in the general context of computer-executable instructions of a computer program product that runs on a computer and/or computers, those skilled in the art will recognize that some of the embodiments herein also can be implemented at least partially in parallel with one or more other program modules. Generally, program modules include routines, programs, components, and/or data structures that perform particular tasks and/or implement particular abstract data types. Moreover, the described computer-implemented methods can be practiced with other computer system configurations, including single-processor and/or multiprocessor computer systems, mini-computing devices, mainframe computers, as well as computers, hand-held computing devices (e.g., PDA, phone), and/or microprocessor-based or programmable consumer and/or industrial electronics. The illustrated aspects can also be practiced in distributed computing environments in which tasks are performed by remote processing devices that are linked through a communications network. However, one or more, if not all aspects of the embodiments described herein can be practiced on stand-alone computers. In a distributed computing environment, program modules can be located in both local and remote memory storage devices.

As used in this application, the terms “component,” “system,” “platform” and/or “interface” can refer to and/or can include a computer-related entity or an entity related to an operational machine with one or more specific functionalities. The entities described herein can be either hardware, a combination of hardware and software, software, or software in execution. For example, a component can be, but is not limited to being, a process running on a processor, a processor, an object, an executable, a thread of execution, a program, and/or a computer. By way of illustration, both an application running on a server and the server can be a component. One or more components can reside within a process and/or thread of execution and a component can be localized on one computer and/or distributed between two or more computers. In another example, respective components can execute from various computer readable media having various data structures stored thereon. The components can communicate via local and/or remote processes such as in accordance with a signal having one or more data packets (e.g., data from one component interacting with another component in a local system, distributed system and/or across a network such as the Internet with other systems via the signal). As another example, a component can be an apparatus with specific functionality provided by mechanical parts operated by electric or electronic circuitry, which is operated by a software and/or firmware application executed by a processor. In such a case, the processor can be internal and/or external to the apparatus and can execute at least a part of the software and/or firmware application. As yet another example, a component can be an apparatus that provides specific functionality through electronic components without mechanical parts, where the electronic components can include a processor and/or other means to execute software and/or firmware that confers at least in part the functionality of the electronic components. In an aspect, a component can emulate an electronic component via a virtual machine, e.g., within a cloud computing system.

In addition, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. Moreover, articles “a” and “an” as used in the subject specification and annexed drawings should generally be construed to mean “one or more” unless specified otherwise or clear from context to be directed to a singular form. As used herein, the terms “example” and/or “exemplary” are utilized to mean serving as an example, instance, or illustration. For the avoidance of doubt, the subject matter described herein is not limited by such examples. In addition, any aspect or design described herein as an “example” and/or “exemplary” is not necessarily to be construed as preferred or advantageous over other aspects or designs, nor is it meant to preclude equivalent exemplary structures and techniques known to those of ordinary skill in the art.

As it is employed in the subject specification, the term “processor” can refer to substantially any computing processing unit and/or device comprising, but not limited to, single-core processors; single-processors with software multithread execution capability; multi-core processors; multi-core processors with software multithread execution capability; multi-core processors with hardware multithread technology; parallel platforms; and/or parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components, and/or any combination thereof designed to perform the functions described herein. Further, processors can exploit nano-scale architectures such as, but not limited to, molecular and quantum-dot based transistors, switches, and/or gates, in order to optimize space usage and/or to enhance performance of related equipment. A processor can be implemented as a combination of computing processing units.

Herein, terms such as “store,” “storage,” “data store,” data storage,” “database,” and substantially any other information storage component relevant to operation and functionality of a component are utilized to refer to “memory components,” entities embodied in a “memory,” or components comprising a memory. Memory and/or memory components described herein can be either volatile memory or nonvolatile memory or can include both volatile and nonvolatile memory. By way of illustration, and not limitation, nonvolatile memory can include read only memory (ROM), programmable ROM (PROM), electrically programmable ROM (EPROM), electrically erasable ROM (EEPROM), flash memory and/or nonvolatile random-access memory (RAM) (e.g., ferroelectric RAM (FeRAM). Volatile memory can include RAM, which can act as external cache memory, for example. By way of illustration and not limitation, RAM can be available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), direct Rambus RAM (DRRAM), direct Rambus dynamic RAM (DRDRAM) and/or Rambus dynamic RAM (RDRAM). Additionally, the described memory components of systems and/or computer-implemented methods herein are intended to include, without being limited to including, these and/or any other suitable types of memory.

What has been described above includes mere examples of systems and computer-implemented methods. It is, of course, not possible to describe every conceivable combination of components and/or computer-implemented methods for purposes of describing the various embodiments, but one of ordinary skill in the art can recognize that many further combinations and/or permutations of the various embodiments are possible. Furthermore, to the extent that the terms “includes,” “has,” “possesses,” and the like are used in the detailed description, claims, appendices and/or drawings such terms are intended to be inclusive in a manner similar to the term “comprising” as “comprising” is interpreted when employed as a transitional word in a claim.

The descriptions of the various embodiments have been presented for purposes of illustration but are not intended to be exhaustive or limited to the embodiments described herein. Many modifications and variations will be apparent to those of ordinary skill in the art without departing from the scope and spirit of the described embodiments. The terminology used herein was chosen to best explain the principles of the embodiments, the practical application and/or technical improvement over technologies found in the marketplace, and/or to enable others of ordinary skill in the art to understand the embodiments described herein.

What is claimed is:

1. A system, comprising:
a processor that executes computer executable components stored in memory, wherein the computer executable components comprise:
an analysis component that evaluates historical change requests, identifies system dependencies, and detects interdependencies;
a recommendation component that uses a large language model and a knowledge graph to retrieve similar change requests and generate recommendations; and
a mitigation component that calculates a risk score based on historical data, failures, and dependency analysis to provide preventive measures.

2. The system of claim 1, wherein the analysis component extracts entities from a change request using semantic role labeling to classify system components.

3. The system of claim 1, wherein the analysis component generates a system dependency graph using causal analysis.

4. The system of claim 1, wherein the recommendation component retrieves similar change requests using multimodal fusion to combine text, system dependencies, or performance metrics.

5. The system of claim 1, wherein the recommendation component ranks retrieved change requests using diversity-aware algorithms to ensure broad scenario representation.

6. The system of claim 1, wherein the mitigation component assigns the risk score using uncertainty quantification and adjusts approval thresholds dynamically.

7. The system of claim 1, further comprising a monitoring component that tracks system behavior post-change and updates historical data.

8. The system of claim 7, wherein the monitoring component applies anomaly detection to identify performance deviations and trigger rollback suggestions.

9. The system of claim 1, further comprising a prescriptive analytics component that generates action recommendations using decision trees and optimization algorithms.

10. The system of claim 1, further comprising an adaptive thresholding component that dynamically adjusts a threshold of the risk score based on system performance trends and user-defined risk tolerance.

11. A computer-implemented method that utilizes a processor that executes computer executable components stored in memory to perform the following acts:
evaluating historical change requests;
identifying system dependencies;
detecting interdependencies;
using a large language model and a knowledge graph to retrieve similar change requests and generate recommendations; and
calculating a risk score based on historical data, failures, and dependency analysis to provide preventive measures.

12. The method of claim 11, further comprising extracting entities from a change request using semantic role labeling to classify system components.

13. The method of claim 11, further comprising generating a system dependency graph using causal analysis.

14. The method of claim 11, further comprising retrieving similar change requests using multimodal fusion to combine text, system dependencies, or performance metrics.

15. The method of claim 11, further comprising ranking retrieved change requests using diversity-aware algorithms to ensure broad scenario representation.

16. The method of claim 11, further comprising assigning the risk score using uncertainty quantification and adjusting approval thresholds dynamically.

17. The method of claim 11, further comprising tracking system behavior post-change and updating historical data.

18. The method of claim 17, further comprising applying anomaly detection to identify performance deviations and trigger rollback suggestions.

19. The method of claim 11, further comprising generating action recommendations using decision trees and optimization algorithms.

20. A computer program product comprising a computer readable storage medium having program instructions embodied therewith, the program instructions executable by a processor to cause the processor to:
evaluate historical change requests;
identify system dependencies;
detect interdependencies;
use a large language model and a knowledge graph to retrieve similar change requests and generate recommendations; and
calculate a risk score based on historical data, failures, and dependency analysis to provide preventive measures.
